(19) United States
(12) Patent Application Publication
(10) Pub. No.: US 2015/0046207 A1
(43) Pub. Date: Feb. 12, 2015

(54) System, Method, and Computer Program Product for Automatically Scheduling a Plurality of Tasks

(71) Applicants: Hollis T. Hurd, (US); Ravi Starzi, (US)

(72) Inventors: Hollis T. Hurd, Bridgeville, PA (US); Ravi Starzi, Pittsburgh, PA (US)

(21) Appl. No.: 14/453,928

(22) Filed: Aug. 7, 2014

Related U.S. Application Data
(60) Provisional application No. 61/863,534, filed on Aug. 8, 2013.

(51) Int. Cl. G06Q 10/06; G06F 3/0484

(52) U.S. Cl. CPC G06Q 10/06313; G06F 3/0484
USPC 705/7.17

(57) ABSTRACT

A computer-implemented method, system, and computer program product is provided for optimizing a schedule for a plurality of tasks. The method includes receiving user input comprising a plurality of tasks including, for each task of the plurality of tasks, a due date and an estimated time required for completion. The method also includes determining, with at least one processor and for each task of the plurality of tasks, an urgency factor based at least partially on the due date and the estimated time required for completion. The method also includes distributing, with at least one processor, each task temporally as at least one time entry in an electronic calendar, the distribution of each task based at least partially on the urgency factor for each task.

### CROSS REFERENCE TO RELATED APPLICATIONS

This application claims benefit of priority from U.S. Provisional Patent Application No. 61/863,534, filed Aug. 8, 2013, which is incorporated herein by reference in its entirety.

### BACKGROUND OF THE INVENTION

1. Field of the Invention

The present invention relates to scheduling and, in particular, a system, method, and computer program product for automatically scheduling a plurality of tasks to be completed in a given period of time.

2. Description of Related Art

Traditional electronic calendars allow users to schedule tasks and reminders manually by choosing a date, time, and duration for each task or for each time that the task will be worked on. These traditional systems allow for ad hoc modification, but are inflexible and difficult to maintain. For example, the various tasks in a traditional electronic calendar are discrete. One task does not depend upon another task and are not affected by other tasks unless those tasks overlap or otherwise conflict. Even in circumstances where tasks overlap, traditional electronic calendars will merely provide an alert that requires manual intervention on behalf of the user.

A user of a traditional electronic calendar, like a paper calendar, must plan and schedule the calendar on an entry-by-entry basis. For example, if a given task is estimated to take 20 hours, a user would have to divide the required 20 hours into a number of time entries, and fit those time entries around existing tasks and/or obligations. The discrete nature of each task and time entry leads to results where, if one task or time entry exceeds a given time or is completed earlier than estimated, the remaining tasks must be manually adjusted.

### SUMMARY OF THE INVENTION

It is therefore an object of the present invention to provide a system, method, and computer program product for scheduling a plurality of tasks that overcome some or all of the above-described deficiencies of the prior art.

According to a preferred and non-limiting embodiment of the present invention, provided is a method for optimizing a schedule for a plurality of tasks, comprising: receiving user input comprising a plurality of tasks including, for each task of the plurality of tasks, a due date and an estimated time required for completion; determining with at least one processor, for each task of the plurality of tasks, an urgency factor based at least partially on the due date and the estimated time required for completion; and distributing each task temporally as a plurality of time entries in an electronic calendar, the distribution of each task based at least partially on the urgency factor for each task.

According to another preferred and non-limiting embodiment, provided is a method for scheduling a plurality of tasks, comprising: receiving user input comprising, for each task of the plurality of tasks, a due date for the task and an estimated time required for the task; and generating with at least one processor, for each task, at least one scheduled time entry in an electronic calendar based at least partially on the due date, the estimated time required, and an available amount of time between a starting date and the due date.

According to a further preferred and non-limiting embodiment, provided is a system for automatically scheduling tasks in an electronic calendar, each task of a plurality of tasks comprising a due date and an estimated time required for completion, the system comprising at least one computer including at least one processor and at least one computer-readable medium including program instructions that, when executed by the at least one processor, cause the at least one computer to: receive user input comprising an availability for a plurality of time periods; receive user input comprising the plurality of tasks, the user input for each task of the plurality of tasks comprising at least a due date and an estimated time required for completion; generate an urgency factor for each task based at least partially on the due date, the availability, and the estimated time required for completion; and generate for each task, based at least partially on the urgency factor and the availability, a schedule comprising a plurality of time entries distributed throughout at least a portion of the plurality of time periods, the schedule generated based at least partially on the urgency factor and the availability for the plurality of time periods.

According to another preferred and non-limiting embodiment, provided is a computer program product for scheduling a plurality of tasks, comprising at least one non-transitory medium comprising program instructions which, when executed by at least one processor, causes the at least one processor to: generate a user interface configured to receive user input comprising a plurality of tasks including, for each task of the plurality of tasks, a due date and a duration; calculate a weight for each task of the plurality of tasks, the weight based at least partially on the due date and the duration for each task; schedule each task of the plurality of tasks over a period of time, wherein each task is scheduled based at least partially on the weight and a time availability.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of a system for scheduling a plurality of tasks according to the principles of the present invention;

FIG. 2 is a step diagram for a method for scheduling a plurality of tasks according to the principles of the present invention; and

FIGS. 3A-3C are graphical user interfaces for a system and method for scheduling a plurality of tasks according to the principles of the present invention.

### DESCRIPTION OF THE PREFERRED EMBODIMENT(S)

For purposes of the description hereinafter, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. It will be appreciated that numerous other arrangements are possible.

According to a preferred and non-limiting embodiment of the present invention, a system for automatically scheduling tasks is implemented using a computer configured with program instructions and one or more processors. The system allows for a user to input a plurality of tasks including, for each task, a due date and an estimated time that the task will take to be completed. The system then processes the task data with the user's availability to determine an optimal distribution of time entries to complete the greatest number of tasks in the least amount of time. The system may be implemented within or in combination with an electronic calendar system, may interface with existing, third-party electronic calendar systems, or may be a stand-alone system. Further, the system may be implemented with desktop, laptop, and mobile computing devices, and may include one or more software applications that run locally and/or remotely, and one or more data structures stored locally and/or remotely.

In a preferred and non-limiting embodiment, the computer includes input devices such as, but not limited to, a mouse, keyboard, microphone, touchscreen, and/or the like, and output devices such as, but not limited to, a display device, a speaker, and/or the like. The display device provides a user with one or more graphical user interfaces (GUIs) that may include various screens, selectable options, prompts, and/or the like. It will be appreciated that selectable options may include, but are not limited to, radio buttons, check boxes, text fields, drop-down menus, selectable text, graphical buttons, icons, and/or the like.

As used herein, the terms “task” or “tasks” refer to one or more activities, projects, assignments, obligations, jobs, and/or the like. A task consumes time and therefore may be associated with parameters such as, but not limited to, an estimated time required for completion, a due date, a start date, a name, an identifier, a category or classification, a sub-category, a priority level, and/or other like parameters. As used herein, the terms “time entry” and “time entries” refer to any scheduled task or portion thereof. A time entry may be defined by a date and time such as, for example, July 12, 9:30 AM to 11:00 AM. A time entry may also be defined by the date alone, indicating that the time entry is for all of the available time on that date. A time entry may be any unit, length, or segment of time and, in non-limiting embodiments, may be in increments of a predetermined duration (e.g., 30 minutes). Each task may comprise one or more time entries. Various other arrangements are possible.

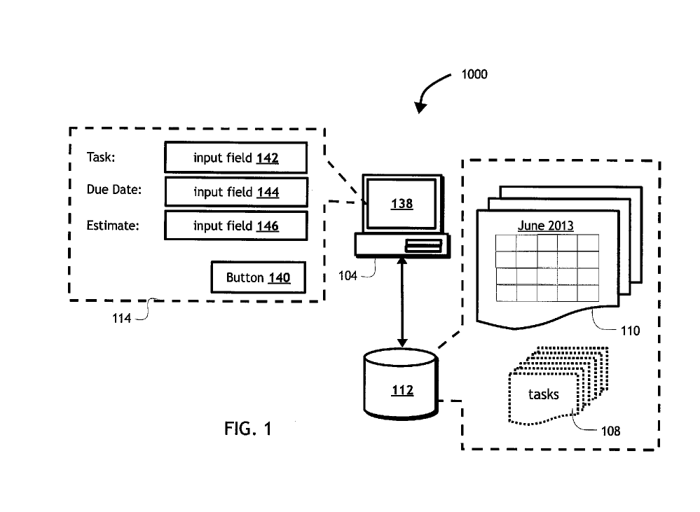

Referring now to FIG. 1, a system 1000 is shown according to a preferred and non-limiting embodiment of the present invention. The system 1000 includes a computer 104 including a processor and a data storage device 112. The data storage device 112 may include one or more local or remote hard disks, memory units, and/or the like, and store one or more data structures including an electronic calendar 110 and a task database 108. The electronic calendar 110 may include a database or module representing the minutes, hours, days, weeks, months, and/or years for a period of time. The electronic calendar may also include various time entries stored in relation to periods of time. However, it will be appreciated that the electronic calendar may be provided in any number of forms, and as explained above may include third-party services and applications. The task database may include one or more data structures configured to store the inputted task parameters.

With continued reference to FIG. 1, a display device 138 is in communication with the computer 104 and may display one or more GUIs 114 showing visual representations of the electronic calendar 110. The GUIs 114 may also include one or more menus or selection screens, dialog or alert boxes, and various selectable options. One such GUI 114 is a time availability GUI, which may include one or more forms for a user to fill out indicating the user's availability during a time period, such as a work week. Once a user's availability is stored, a number of tasks are inputted into a task entry GUI 114 that may comprise a number of input fields 142, 144, 146 and a button 140 to add the inputted task. For each task, an estimated amount of time the task will take and a due date is provided by the user. A schedule GUI may provide the user with a visual representation of the electronic calendar and/or task database.

Several different types and combinations of algorithms may be used to determine an optimal or desired distribution of tasks in the electronic calendar. For example, in a preferred and non-limiting embodiment, an urgency factor may be used as an input in determining how to generate and schedule time entries for a task. The urgency factor for a given task may be, for example, based on the amount of time left from the current date or starting date until the due date, and the amount of remaining time required to complete the task. In a preferred and non-limiting embodiment, the urgency factor is generated by dividing the time left until the due date by the remaining time allotted to the task. It will be appreciated that various other formulae, algorithms, and/or processes may be used to determine an urgency for any given project, and that urgency factors may be in the form of discrete or relative weights, values, and/or the like. Accordingly, as used herein, the term “urgency factor” may refer to any form of metric for indicating a relative importance, urgency, priority, and/or pressure for a given task.

In a preferred and non-limiting embodiment, the system schedules the time entries based on generating urgency factors for each task. The time entries are then scheduled in the electronic calendar according to urgency. This may be performed by ordering the tasks according to urgency in a list or other like data structure. It will be appreciated that various sorting algorithms may be used to sort the tasks into descending order such as a quick sort, merge sort, bubble sort, etc. The most urgent task is scheduled as one or more time entries in the soonest available time period of the electronic calendar. After one or more time entries are scheduled, the due date and time left for completion is adjusted accordingly. The urgency factors for all of the tasks are then recalculated, and the data structure is resorted and the scheduling process continues. Once the urgency factors for multiple tasks are equal or substantially equal, the time entries may then be distributed such that the urgency factors for those tasks remain equal or substantially equal. Various other implementations may be possible and, in some non-limiting embodiments, priorities for some or all tasks may also affect the distribution of time entries.

If one or more tasks have a priority level, those tasks may be scheduled according to both the priority and urgency. The priority level may be a selection of one of a plurality of options (e.g., low priority, normal priority, high priority), or may be a numerical value in a specified range. The priority may also be binary (e.g., high priority or normal priority) and, in some embodiments, may be based on an indication that a task has a “hard” deadline (e.g., a deadline that cannot be changed). When a priority is associated with a task, the distribution of time entries may depend upon the priority and the urgency factor. For example, the urgency level for tasks of a similar priority may be kept substantially equal while the time entries for the tasks are distributed in the electronic calendar. A hard deadline may indicate a deadline that the user must complete on time, such as a tax return or the filing of a legal document. A task indicated to have a hard deadline will be scheduled before those of lesser priority, so tasks having “soft” deadlines never cause the user to miss an important deadline.

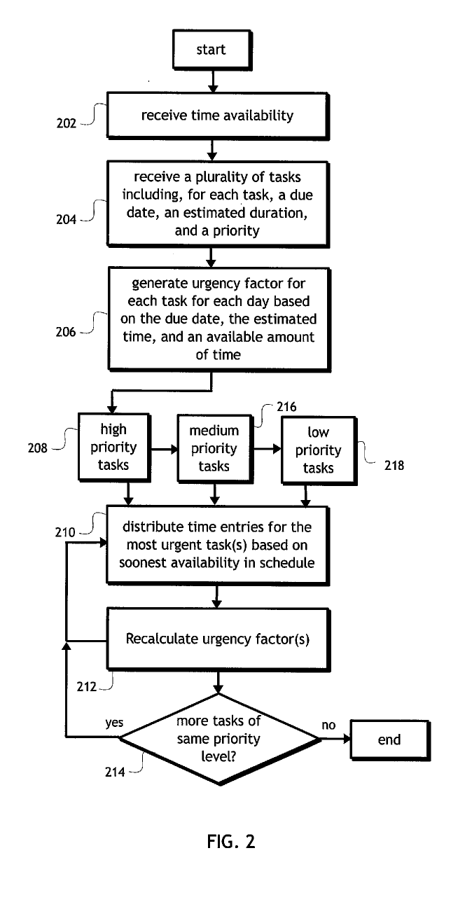

Referring now to FIG. 2, a method for scheduling a plurality of tasks is shown according to a preferred and non-limiting embodiment. At step 202, a user inputs a time availability into an application on a computer and the application receives the input. The time availability may comprise the time periods a user has available for completing the tasks. For example, the available time may be Monday through Friday, 8:00 AM to 5:30 PM, with an hour-long lunch break from 12:00 PM to 1:00 PM. Holidays, vacations, and other events may override a typical work day, and each work day or other period of time may have a specified availability. Time availability may also be recorded on a day-to-day basis as time available in a morning period and time available in an afternoon or evening period (e.g., A.M. and P.M.). For example, a time availability for a given week may indicate that the user is available to work on Monday, Tuesday, and Thursday for three (3) hours in the A.M. time period, and on Wednesday and Friday for two (2) hours in the A.M. period and five (5) hours in the P.M. period.

At step 204, a user inputs the tasks into the application including, for each task, a due date, an estimated duration, and a priority. The priority may include an indication of, for example, low, medium, or high priority. In other non-limiting examples, and as already described, the priority may be binary (e.g., a hard or soft deadline), a sliding scale, a numerical value, and/or the like. As described herein, various other arrangements are possible. Additional parameters may also be entered such as, but not limited to, a description, category or classification, sub-category, and/or the like. Tasks may also be imported from third-party applications and/or calendars.

With continued reference to FIG. 2, an urgency factor is generated for each task at step 206. The urgency factor for the tasks may be continually generated and regenerated as the application temporally iterates through the electronic calendar and schedules time entries. For example, the urgency factor may be generated before any scheduling or distribution takes place, and may be subsequently regenerated each day as the time entries are scheduled. In other non-limiting examples, an initial calculation of an urgency factor can be used to generate the entire schedule of time entries for that task. Once an urgency factor is initially generated at step 206, the tasks may be scheduled in the electronic calendar according to priority. At step 208, if high priority tasks need to be scheduled, the method proceeds to step 210 in which the high priority tasks are scheduled by distributing time entries for the most urgent high priority tasks.

With continued reference to FIG. 2, the method steps through the user's availability in the electronic calendar, distributing time entries for each task starting with the most urgent task. After one or more time entries for the most urgent task or tasks are scheduled, at step 212 the urgency factors are recalculated. The method then loops back to step 210, and one or more time entries are distributed and the urgency factors are again recalculated. At step 214, a determination is made if there are more tasks of the same priority level. If there are more tasks of that priority level, the method loops back to step 210. Once all of the tasks of that priority level have been scheduled, this process ends and the method continues from step 208 to step 216. At step 216, the steps 210, 212, 214 are repeated for tasks of medium priority and, at step 218, the steps 210, 212, 214 are repeated again for tasks of low priority.

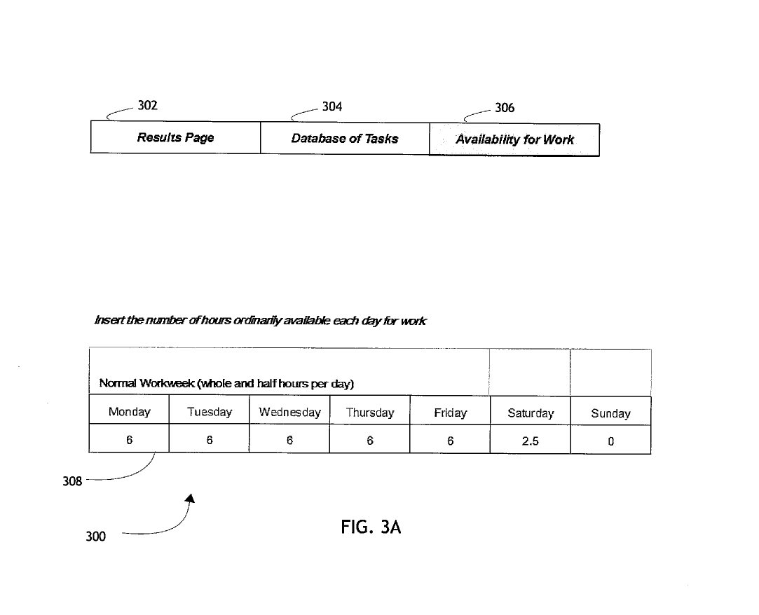

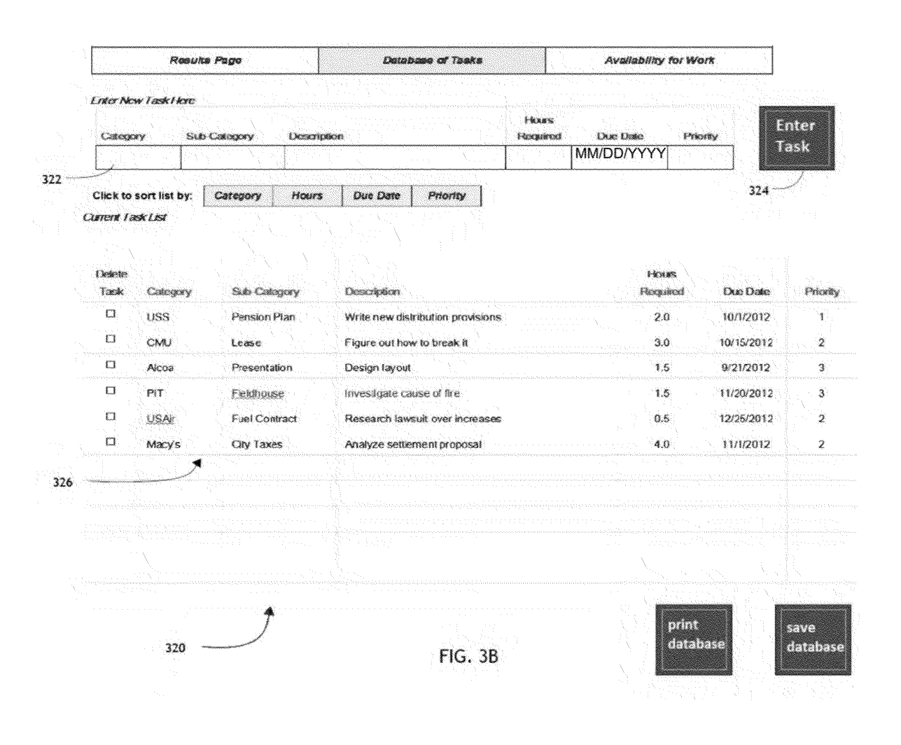

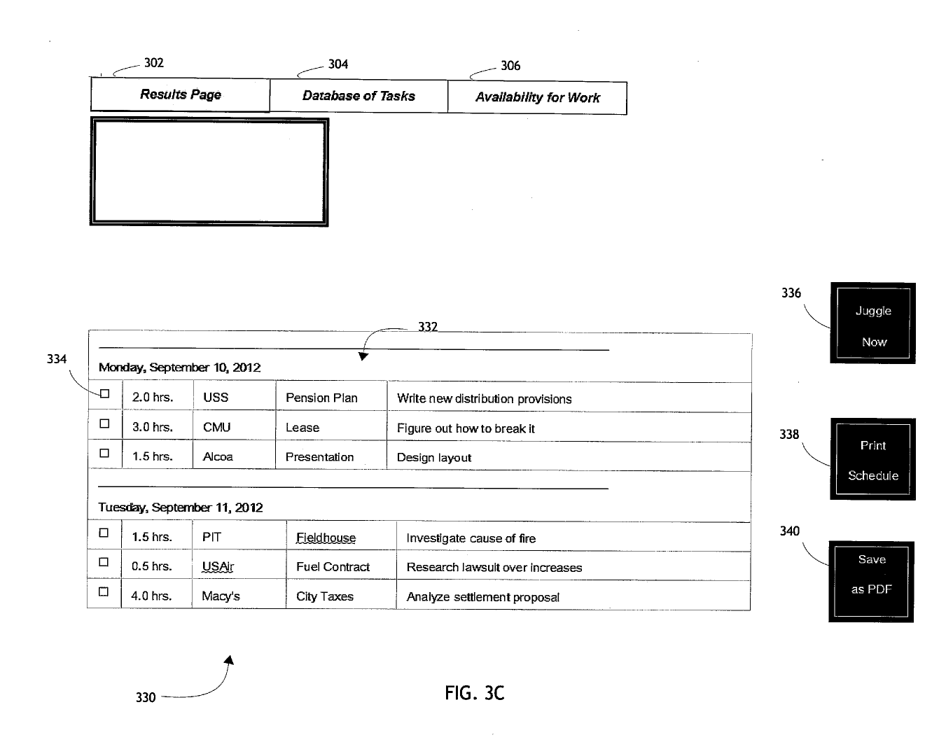

Referring now to FIGS. 3A-3C, a series of GUIs are shown according to a preferred and non-limiting embodiment. Although several GUIs are shown for different functions of the system 1000, it will be appreciated that the system may be implemented with one (1) or several GUIs including various windows, pop-ups, dialog boxes, screens, tabs, and/or the like. The GUIs may have a series of selectable options to switch between GUIs. These options may include, for example, a schedule option 302, a task entry option 304, and a time availability option 306. As will be described below, in one non-limiting example, the schedule option 302 may display the schedule GUI, the task entry option 304 may display the task entry GUI, and the time availability option 306 may display the time availability GUI. An “undo” option may be provided on one or more of the GUIs to allow a user to step backwards and undo any action or operation previously performed.

With reference to FIG. 3A, a time availability GUI 300 is shown according to non-limiting embodiment. In the GUI 300, a user is able to enter an amount of available time for each day of a week. A time availability entry table 308 may have fields for users to select or type a number of hours and/or minutes available for each day. In some non-limiting examples, the availability may be expressed as increments of thirty minutes. Various other arrangements are possible. In some non-limiting embodiments, a blank entry will be assigned a null or zero value by default. Moreover, the time availability may be less than a user's typical workday, allowing for meetings, calls, and other like interruptions. However, this availability or lack thereof be input at the user's discretion.

The time availability GUI 300 may also include a visual representation of the electronic calendar. This visual representation may include each day divided into a morning (A.M.) and an afternoon/evening (P.M.). The calendar units may be selectable options, allowing a user to select days and time periods of availability or unavailability. For example, clicking on an A.M portion of a day may indicate that the morning is unavailable for tasks, and that portion of the calendar may be grayed out, marked, or otherwise indicated to be unavailable. Various other arrangements are possible to facilitate a user to select or indicate his or her availability or unavailability. In some non-limiting embodiments, events, obligations, holidays, and meetings may be imported to indicate time periods of unavailability.

Referring now to FIG. 3B, a task entry and schedule GUI 320 is shown according to a preferred and non-limiting embodiment. A task entry table 322 may have fields for users to select or enter task parameters such as a category, a sub-category, a description, the hours required (e.g., estimated time required for completion), a due date, and a priority. An enter task option 324 creates a record of the task according to the parameters in the task entry table 322. The task database 326 may be displayed and visualized in any number of ways, and may list each task including the task parameters. Options to delete and/or edit each task may be provided. Further, in some non-limiting embodiments, sort options are provided to sort the task database 326 according to category, hours, due date, priority, and/or the like.

Referring now to FIG. 3C, a schedule GUI 330 is shown according to a preferred and non-limiting embodiment. The schedule GUI 330 may include an optimized schedule of time entries for each task over a period of time. In FIG. 3C, two time periods (days) are shown. A day schedule table 332 displays the time entries scheduled according to urgency and/or priority. Each task may be displayed with an amount of time allotted, an amount or percentage of the task that will be completed after the time entry, and the projected urgency factor value after the allotted time is completed. Various other parameters and metrics may also be displayed. The tasks may also be displayed with color codes and/or icons to represent different priorities, notations, or attributes. High-priority tasks may be highlighted in red, for example, or accompanied by an alert icon.

With continued reference to FIG. 3C, a completion option 334 is provided next to each time entry for a user to indicate that the time entry has been completed. The completion option 334 may update the task database to reflect a change in the number of hours still required, if any, for the task. A rescheduling option 336 is provided on the GUI 330 that, when selected, determines an optimal schedule based on the task database, a current date and/or time, and any new, completed, or modified tasks from the task database. The rescheduling option 336 may regenerate the schedule anew, taking into account the data entered into the other GUIs and stored in the task database.

With continued reference to FIG. 3C, a print option 338 facilitates the schedule to be printed, and may provide for various print options such as, but not limited, to daily, weekly, and/or monthly calendar printouts. A save option 340 may save the schedule as a specified file type, or may export the schedule to a third-party application or service. In non-limiting embodiments, options may be provided to export the schedule to a mobile application, a network-based storage service, a third-party calendar system, a local or remote back-up storage location, and/or the like. Back-ups may be performed automatically at predetermined intervals and/or upon selection of a back-up option by a user. An import option may also be provided to import tasks, a calendar, or any other data from another data source.

In a preferred and non-limiting embodiment, a final or last time entry for a task (e.g., the time entry that represents completion of the total amount of time estimated to complete the task) may be indicated to the user. For example, the time entry may be highlighted, flagged, bolded, and/or the like, allowing a user to add to the number of hours needed to complete if necessary. Adding to the number of hours in the task database may then automatically reschedule the tasks or, in other examples, the tasks may be rescheduled upon selection of the rescheduling option 336 on the schedule GUI 330 or elsewhere.

In a preferred and non-limiting embodiment, the system 1000 may be configured to handle situations in which tasks are unable to be completed before a specified due date. For example, when time entries are being distributed, the scheduling of a time entry past its due date may cause an alert or notification to appear. The alert or notification may also be displayed after all time entries have been distributed, listing all of the tasks that are unable to be completed by their respective due date. Options may be provided to the user to solve the overflow problem by modifying the task parameters and/or time availability. The user may reduce the time required for one or more tasks, extend the due dates for one or more tasks, change a priority for one or more tasks, modify the time availability for one or more days, and/or the like. For example, the user may indicate an availability to work an extra two (2) hours each Wednesday, and may then reschedule the tasks to see if the change in availability solves the overflow problem. In some non-limiting embodiments, the system 1000 may automatically generate suggestions for the user to solve the overflow problem. If the overflow problem is not corrected, the tasks may be scheduled past the due dates and a warning provided the user.

In a preferred and non-limiting embodiment, a user may create a new task as a priority component of an existing task. In this way, the parameters of the existing task may be adjusted to account for the priority component scheduled as a new task. Moreover, a user may create a new task to determine if a new task is feasible. For example, if a user wants to determine if a task can be incorporated into the user's schedule, the new task may be input and the task database may be subsequently rescheduled. If the new task results in an alert or notification indicating that it cannot be accomplished by the due date, or if it results in a different task missing a due date, the user then knows that the task is not feasible. As explained herein, the user may also alter various tasks and time availabilities to fit the new task into the schedule.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method for optimizing a schedule for a plurality of tasks, comprising:
receiving user input comprising a plurality of tasks including, for each task of the plurality of tasks, a due date and an estimated time required for completion;
determining, with at least one processor and for each task of the plurality of tasks, an urgency factor based at least partially on the due date and the estimated time required for completion;
distributing, with at least one processor, each task temporally as at least one time entry in an electronic calendar, the distribution of each task based at least partially on the urgency factor for each task.

2. The method of claim 1, further comprising: recalculating the urgency factor for each task while distributing each task temporally, such that the urgency factor for each task decreases over time.

3. The method of claim 1, wherein the due date for each task comprises at least one of a date and a time by which the task must be completed.

4. The method of claim 1, wherein the estimated time required for completion comprises a number of hours required to perform the task.

5. The method of claim 1, wherein the plurality of tasks further includes, for each task of the plurality of tasks, a priority level, and wherein the urgency factor for each task is determined based at least partially on the priority level.

6. The method of claim 5, wherein the priority level comprises at least one of the following: high priority, normal priority, low priority, or any combination thereof.

7. The method of claim 5, wherein the priority level comprises a high priority level and a standard priority level, and wherein the high priority level is based on an indication that a deadline is a hard deadline.

8. The method of claim 1, wherein the urgency factor for each task is based at least partially on a ratio of a remaining completion time and a remaining time before or until the due date.

9. The method of claim 8, wherein the remaining completion time comprises a difference between the estimated time required for completion and an amount of time already completed, and wherein the remaining time before or until the due date comprises a difference between the due date and a date associated with a time entry of the plurality of time entries for the task.

10. The method of claim 1, wherein the user input further comprises a time availability for at least one day in the electronic calendar.

11. The method of claim 10, wherein the distribution of each task in the electronic calendar is based at least partially on the time availability for the at least one day.

12. The method of claim 10, further comprising:
determining if a remaining completion time is greater than a sum of the time availability before the due date; and
notifying a user in response to determining that the remaining completion time is greater than the sum.

13. The method of claim 12, wherein notifying the user comprises displaying an alert on at least one user interface.

14. The method of claim 12, further comprising: determining a new distribution of time entries in response to determining that the remaining completion time is greater than the sum.

15. The method of claim 14, further comprising:
displaying selectable options comprising a plurality of different distributions of time entries; and
redistributing the time entries based at least partially on a user selection from the plurality of different distributions of time entries.

16. A method for scheduling a plurality of tasks, comprising:
receiving user input comprising, for each task of the plurality of tasks, a due date for the task and an estimated time required for the task;
generating with at least one processor, for each task, at least one scheduled time entry in an electronic calendar based at least partially on the due date, the estimated time required, and an available amount of time between a starting date and the due date; and
determining with at least one processor, for each task, an urgency factor based at least partially on the due date and the estimated time required, wherein the at least one scheduled time entry is generated based at least partially on the urgency factor for each task.

17. The method of claim 16, wherein the urgency factor for each task is based at least partially on a ratio of a remaining completion time and a remaining time before or until the due date.

18. The method of claim 17, wherein the remaining completion time comprises a difference between the estimated time required for completion and an amount of time already completed, and wherein the remaining time before or until the due date comprises a difference between the due date and a date associated with a time entry of the plurality of time entries for the task.

19. A computer program product for scheduling a plurality of tasks, comprising at least one non-transitory medium comprising program instructions which, when executed by at least one processor, causes the at least one processor to:
generate a user interface configured to receive user input comprising a plurality of tasks including, for each task of the plurality of tasks, a due date and a duration;
calculate a weight for each task of the plurality of tasks, the weight based at least partially on the due date and the duration for each task;
schedule each task of the plurality of tasks over a period of time, wherein each task is scheduled based at least partially on the weight and a time availability.

20. The computer program product of claim 19, wherein each task is scheduled by creating a plurality of time entries in an electronic calendar starting with a current date or a start date, wherein tasks having a higher weight are scheduled before tasks having a lower weight.
